(19) United States
(12) Patent Application Publication
(10) Pub. No.: US 2024/0242700 A1
(43) Pub. Date: Jul. 18, 2024

(54) INSTRUMENT

(71) Applicant: YAMAHA CORPORATION, Hamamatsu-shi (JP)

(72) Inventors: Shingo EKUNI, Hamamatsu-shi (JP); Hidehisa YASUNO, Hamamatsu-shi (JP); Jun ISHII, Hamamatsu-shi (JP)

(21) Appl. No.: 18/409,062

(22) Filed: Jan. 10, 2024

(30) Foreign Application Priority Data
Jan. 13, 2023 (JP) 2023-003667

(51) Int. Cl. G10H 3/22; G10D 1/08

(52) U.S. Cl. CPC G10H 3/22; G10D 1/08

(57) ABSTRACT

An instrument comprises a body including a soundboard that transmits a vibration of a sound source, and a vibration exciter configured to vibrate the soundboard in response to an input signal. The vibration exciter comprises a vibrator member attached to the soundboard and configured to vibrate the soundboard in response to the input signal, a displacement member configured to displace relative to the vibrator member in response to the input signal, and a support member including an elastic member and supporting the displacement member via the elastic member with respect to the body. At least part of the vibration exciter overlaps a center of a region of the soundboard that extends in a width direction from a contact region of the soundboard where the soundboard contacts with the vibrator member.

### CROSS-REFERENCE TO RELATED APPLICATIONS

This application claims the benefit of priority to Japanese Patent Application No. 2023-003667, filed on Jan. 13, 2023, the entire contents of which are incorporated herein by reference.

### FIELD

The present disclosure relates to an instrument.

### BACKGROUND

Among the instruments, there is an instrument that generates sound by vibrating a soundboard or the like to which a vibration of a sound source is transmitted by a vibration exciter.

For example, Japanese laid-open patent publication No. 2017-129694 discloses an acoustic guitar to which a vibration exciter for vibrating a backboard according to an input signal is attached as such an instrument. In addition, U.S. Pat. No. 11,308,929 discloses a stringed instrument having a vibration exciter attached to a body for vibrating the body.

### SUMMARY

According to an embodiment of the present disclosure, an instrument comprises a body including a soundboard that transmits a vibration of a sound source and a vibration exciter configured to vibrate the soundboard in response to an input signal. The vibration exciter comprises a vibrator member attached to the soundboard and configured to vibrate the soundboard in response to the input signal, a displacement member configured to displace relative to the vibrator member in response to the input signal and a support member including an elastic member and supporting the displacement member via the elastic member with respect to the body. At least part of the vibration exciter overlaps a center of a region of the soundboard that extends in a width direction from a contact region of the soundboard where the soundboard contacts with the vibrator member.

According to an embodiment of the present disclosure, an instrument comprises a body including a soundboard that transmits a vibration of a sound source and a vibration exciter configured to vibrate the soundboard in response to an input signal. The vibration exciter comprises a vibrator member attached to the soundboard and configured to vibrate the soundboard in response to the input signal, a displacement member configured to displace relative to the vibrator member in response to the input signal and a support member including an elastic member and supporting the displacement member via the elastic member with respect to the body. A distance between a center of a contact region of the soundboard in contact with the vibrator member and a center of a region extending in a width direction from the contact region is equal to or less than half of a length of the support member in the width direction.

According to an embodiment of the present disclosure, an instrument comprises a body including a soundboard that transmits a vibration of a sound source, a vibration exciter configured to vibrate the soundboard in response to an input signal. The vibration exciter comprises a vibrator member fixed to the soundboard and configured to vibrate the soundboard in response to the input signal, a displacement member configured to displace relative to the vibrator member in response to the input signal and a support member including an elastic member and supporting the displacement member via the elastic member with respect to the body. At least part of the vibration exciter overlaps a symmetry axis of a predetermined vibration mode in the soundboard.

### BRIEF DESCRIPTION OF DRAWINGS

FIG. 1 is a front view showing an acoustic guitar according to a first embodiment of the present disclosure.

FIG. 2 is a plan view showing an inside part of a backboard of a body of the guitar shown in FIG. 1.

FIG. 3 is a cross-sectional view along a line A1-A2 in FIG. 2.

FIG. 4 is a diagram for explaining a position where a vibration exciter is attached.

FIG. 5 is a diagram for explaining an example of a position where a vibration exciter is attached.

FIG. 6 is a diagram for explaining an example of a position where a vibration exciter is attached.

FIG. 7 is a diagram for explaining an example of a position where a vibration exciter is attached.

FIG. 8 is a diagram showing an example of a vibration mode of a backboard of a guitar body to which no vibration exciter is attached.

FIG. 9 is a diagram showing an example of a vibration mode of a backboard of a guitar body to which a vibration exciter is attached.

FIG. 10 is a diagram showing an example of a vibration mode of a backboard of a guitar body to which a vibration exciter is attached.

FIG. 11 is a view of a surface of a vibrator member viewed from an inside surface side toward a Z-axis direction.

### DESCRIPTION OF EMBODIMENTS

In the case where a vibration exciter having a predetermined weight is attached on an acoustic member such as a top board or backboard of an acoustic guitar, the vibration characteristics of the acoustic member are affected by the weight of the vibration exciter. Therefore, the vibration characteristics of the acoustic member are different between the case where the vibration exciter is not attached and the case where the vibration exciter is attached.

According to the present disclosure, even when the vibration exciter is attached to the acoustic member, it is possible to suppress fluctuations in the vibration characteristics of the acoustic member.

Hereinafter, an embodiment of the present disclosure will be described in detail with reference to the drawings. The following embodiments are examples, and the present disclosure should not be construed as being limited to these embodiments. In the drawings referred to in the present embodiment, the same portions or portions having similar functions are denoted by the identical signs or similar signs (signs each formed simply by adding A, B, etc. to the end of a number), and a repetitive description thereof may be omitted. Dimensional ratios may be different from actual ratios, or part of a configuration may be omitted from the drawings for clarity of explanation in the drawings.

A vibration exciter having a predetermined weight can be attached to an acoustic member of an instrument according to an embodiment. Even when the vibration exciter is attached to the acoustic member of the instrument according to an embodiment, fluctuations in the vibration characteristics of the acoustic member by the vibration exciter are suppressed. That is, the vibration of the acoustic member is less likely to be limited by the vibration exciter. This is achieved by adjusting the attachment position of the vibration exciter on the acoustic member. Hereinafter, an instrument according to an embodiment will be described. The case where an instrument is an acoustic guitar will be described as an example in the embodiment described below. However, an instrument according to the present disclosure is not limited to an acoustic guitar.

### First Embodiment

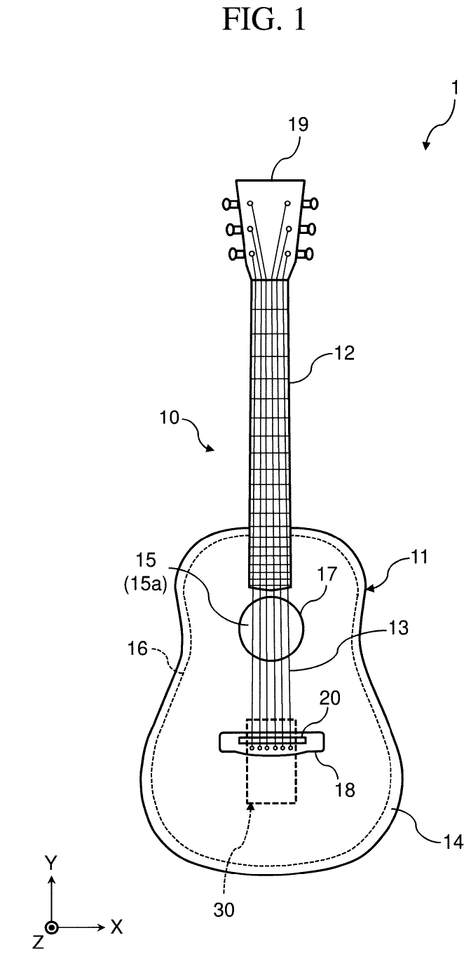

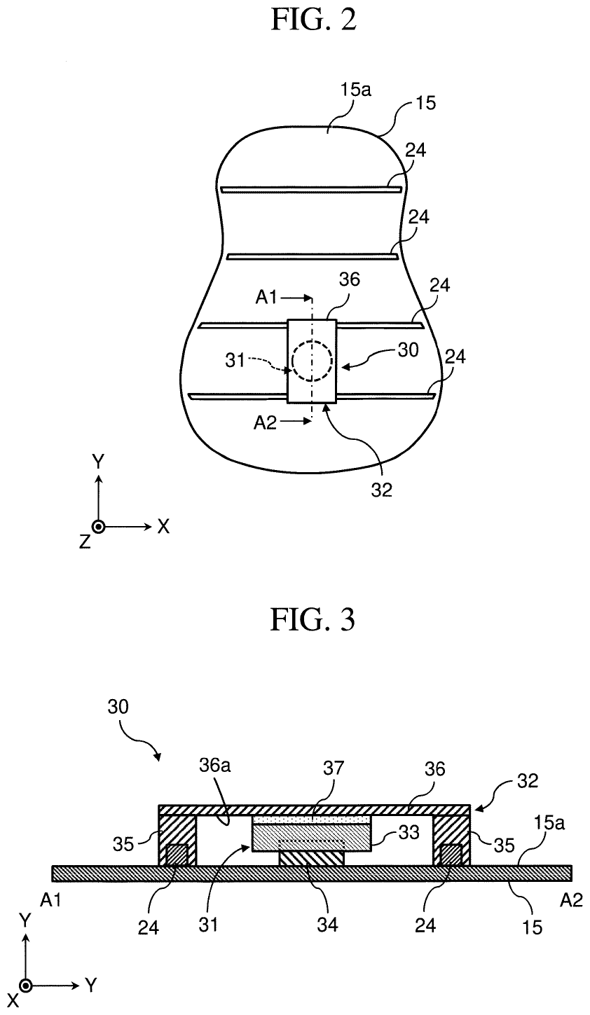

An instrument according to an embodiment of the present disclosure will be described with reference to FIG. 1 to FIG. 3. FIG. 1 is a front view showing an acoustic guitar according to a first embodiment. FIG. 2 is a plan view of an inside surface of a backboard of a body of the guitar shown in FIG. 1 viewed from a direction perpendicular to the inside surface. FIG. 3 is a cross-sectional view along a line A1-A2 in FIG. 2.

As shown in FIG. 1, an acoustic guitar 1 (hereinafter referred to as a guitar 1) includes a guitar body 10 (instrument body) and a vibration exciter 30. The guitar body 10 includes a body 11, a neck 12, and strings 13.

The body 11 is formed in a box shape having a cavity inside. The body 11 includes a top board 14, a backboard 15, and sides 16. The top board 14 and the backboard 15 are flat boards having the same shape. The top board 14 and the backboard 15 are arranged apart from each other in a thickness direction of these boards. The sides 16 extend from a peripheral edge of the backboard 15 to a peripheral edge of the top board 14. The top board 14, the backboard 15, and the sides 16 constitute the body 11 having a cavity inside. A direction in which the top board 14 and the backboard 15 are arranged (a Z-axis direction) may be referred to as an up-down direction in the following description.

A sound hole 17 that penetrates in the plate thickness direction is formed in the top board 14. The sound hole 17 connects the cavity of the body 11 to the space outside the body 11. In addition, a bridge 18 that fastens a first end of the strings 13 in a longitudinal direction is arranged on an outer surface of the top board 14.

The neck 12 extends from the body 11 in a direction substantially orthogonal to the up-down direction (the Z-axis direction). A head 19 for winding a second end of the strings 13 in the longitudinal direction is arranged at a tip of the neck 12. A direction orthogonal to the up-down direction and in which the neck 12 mainly extends (a Y-axis direction) may be referred to as an anterior-posterior direction in the following explanation. In addition, a direction orthogonal to the up-down direction and anterior-posterior direction may be referred to as a left-right direction (an X-axis direction).

The strings 13 are stretched over the body 11 and the neck 12 in the anterior-posterior direction. Specifically, the first end of the strings 13 is fastened to the bridge 18 of the body 11, and the second end side of the strings 13 is wound at the head 19. Therefore, the strings 13 are stretched between the bridge 18 and the head 19.

A vibration transmission part 20 (a saddle) is arranged between the strings 13 and the outer surface of the top board 14. As a result, the vibration of the strings 13 is transmitted to the top board 14 via the vibration transmission part 20, so that the top board 14 vibrates, and further, the backboard 15 and the sides 16 vibrate in the guitar 1. As a result, the air in the body 11 (the cavity) resonates, and the sound is radiated to the outside of the body 11.

The backboard 15 of the body 11 has an inside surface 15afacing the top board 14 in the up-down direction. As shown in FIG. 2, four ribs 24 are attached on the inside surface 15a of the backboard 15. Each of the ribs 24 is fixed at a predetermined position by bonding or the like to the inside surface 15a. The shape, the number, the position, and the like of the rib 24 exemplified in FIG. 2 are examples, and the position and the like may be changed as appropriate depending on the purpose of increasing the rigidity of the backboard 15, the purpose of adjusting the tone of the guitar 1, and the like.

Each of the four ribs 24 is formed in a rod shape extending along the inside surface 15a. Each of the ribs 24 is arranged so that its longitudinal direction is parallel to the left-right direction. The four ribs 24 are spaced apart from each other in the anterior-posterior direction. Part of the backboard 15 where the rib 24 is arranged has higher rigidity than the other parts of the backboard 15. Therefore, the part of the backboard 15 where the rib 24 is arranged is less likely to vibrate than the other parts of the backboard 15, and is highly likely to become a node of vibration.

Although not shown in FIG. 2, a peel-off stop may be arranged on the inside surface 15a. The peel-off stop is formed in a strip shape extending along the inside surface 15a. The peel-off stop is arranged at a center of the inside surface 15a of the backboard 15 in the left-right direction so that the longitudinal direction thereof is parallel to the anterior-posterior direction. The peel-off stop prevents peeling of the adhesion of the backboard 15 formed by bonding the two plate members at the center in the left-right direction.

As shown in FIG. 3, the vibration exciter 30 includes a vibration exciter body 31 (hereinafter referred to as a body 31) and a support member 32.

The body 31 vibrates the backboard 15 (a soundboard) of the body 11 described above. The body 31 includes a displacement member 33 and a vibrator member 34. The body 31 is connected to an output device (not shown). The body 31 may be connected to the output device by wire, or may be wirelessly connected to the output device so that a wireless unit (not shown) arranged in the body 31 receives a signal from the output device. The output device outputs an input signal (an electric signal) generated based on pre-stored music data, sound data, voice data, or a signal indicating a vibration of a sound source (the strings 13) of the guitar 1 to the body 31. The body 31 of the vibration exciter 30 receives the input signal supplied from the output device. The body 31 vibrates the backboard 15 in response to the input signal.

Specifically, the displacement member 33 is displaced relative to the vibrator member 34 in response to the input signal. The displacement member 33 vibrates so as to be displaced relative to the vibrator member 34 in response to the input signal. Since the displacement member 33 is supported by the support member 32, the vibrator member 34 vibrates due to the vibration of the displacement member 33. The vibrator member 34 is in contact with and fixed to the inside surface 15a of the backboard 15. The vibrator member 34 vibrates the backboard 15. For example, the body 31 may be a voice-coil type actuator. In this case, the displacement member 33 may have a magnetic portion, and the vibrator member 34 may have a voice coil. A weight of the displacement member 33 is sufficiently heavier than a weight of the vibrator member 34. As a result, the vibrator member 34 can also vibrate due to the vibration of the displacement member 33. Although not shown, an elastic member for guiding the vibration of the vibrator member 34 may be arranged between the displacement member 33 and the vibrator member 34.

The support member 32 is interposed between the backboard 15 and the displacement member 33. The support member 32 is attached to the inside surface 15a of the backboard 15. The support member 32 supports the displacement member 33 so that the vibrator member 34 contacts the inside surface 15a of the backboard 15 and the displacement member 33 elastically displaces relative to the backboard 15. Hereinafter, a specific configuration of the support member 32 will be described.

The support member 32 includes a supporting leg 35, a bracket 36, and an elastic member 37. The supporting leg 35 extends upward (in the positive Z-axis direction) from the inside surface 15a of the backboard 15. Each of the two supporting legs 35 is fixed to each of the two ribs 24 adjacent to each other in the anterior-posterior direction on the inside surface 15a of the backboard 15 in the present embodiment. The supporting leg 35 may be fixed to the rib 24 by an adhesive (not shown) or the like.

The bracket 36 is a member that fixes the body 31. The bracket 36 is formed in a plate shape or a sheet shape having the up-down direction as a thickness direction. The bracket 36 is arranged at a tip of the supporting leg 35. Specifically, an edge portion of the bracket 36 is supported by the supporting leg 35. As a result, the bracket 36 is arranged apart from the inside surface 15a of the backboard 15 in the up-down direction. The bracket 36 may be fixed to the tip of the supporting leg 35 by a screw, an adhesive (not shown), or the like.

The displacement member 33 is fixed to the bracket 36 on an opposite surface 36a side facing the inside surface 15a of the backboard 15 via the elastic member 37. The elastic member 37 has flexibility. A material constituting the elastic member 37 may be a resin material, a metal material, or the like. Since the elastic member 37 has flexibility, the displacement member 33 fixed to the bracket 36 via the elastic member 37 is elastically displaced relative to the backboard 15.

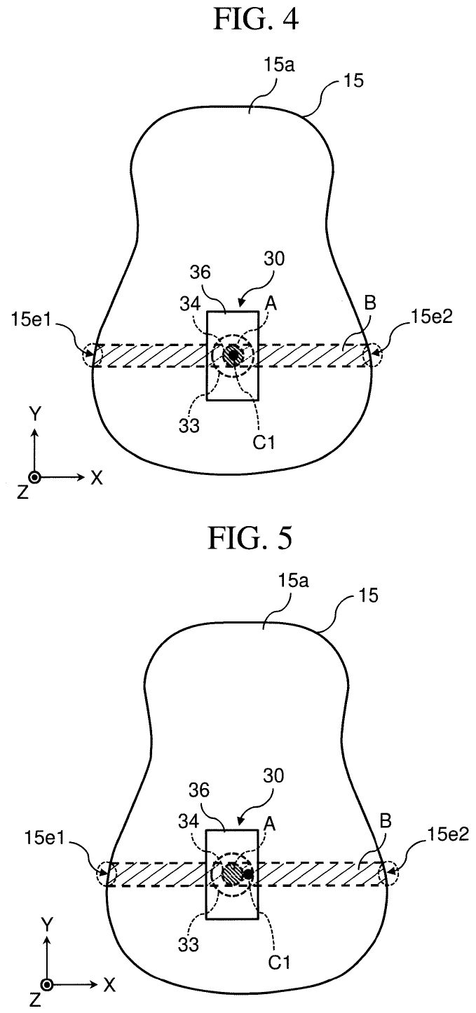

FIG. 4 to FIG. 7 are diagrams for explaining a position where the vibration exciter 30 is attached on the backboard 15. Similar to FIG. 2, FIG. 4 to FIG. 6 show a plan view in the case where the inside surface 15a of the backboard 15 is viewed from a direction perpendicular to the inside surface 15a (that is, the Z-axis direction). As shown in FIG. 4 to FIG. 6, when the inside surface 15a is viewed from the direction perpendicular to the inside surface 15a, the vibration exciter 30 is arranged so that at least part of the vibration exciter 30 overlaps a center C1 of a region B of the backboard 15 (the soundboard) that extends in a width direction from a contact region A , and the contact area A is the area of the backboard 15 that is in contact with the vibrator member 34. Here, the width direction of the backboard 15 (the soundboard) is a direction perpendicular to the direction in which the neck 12 extends, that is, the left-right direction (the X-axis direction). The region B is a region having the same width as the width of the contact region A parallel to the anterior-posterior direction (the Y-axis direction) and including both end portions 15e1 and 15e2 of the backboard 15 in the left-right direction (the X-axis direction).

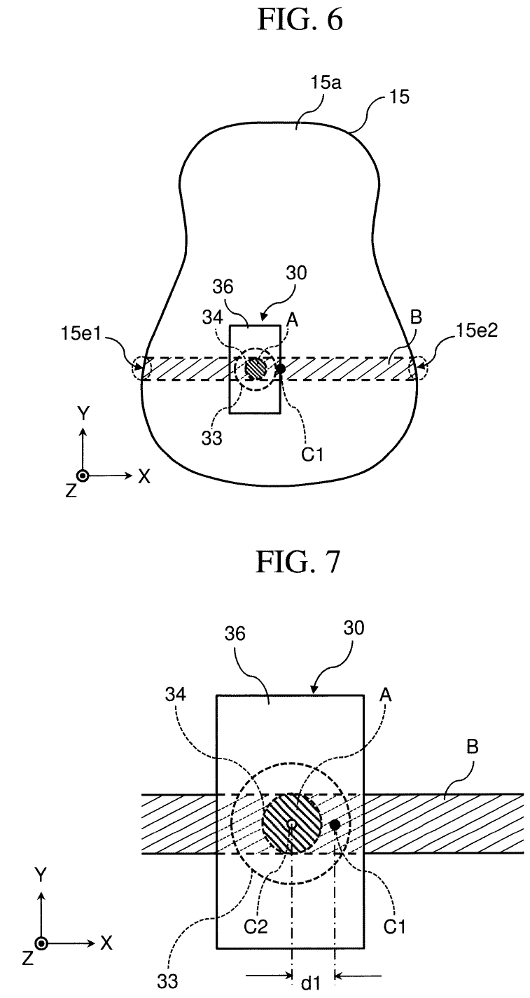

When the inside surface 15a is viewed from a direction perpendicular to the inside surface 15a, at least part of the vibration exciter 30 that overlaps the center C1 of the region B may be at least part of the bracket 36 of the support member 32, may be at least part of the displacement member 33, or may be at least part of the vibrator member 34 (a part of the part of the vibrator member 34 in contacts with the contact region A). FIG. 4 shows the case where a part of the bracket 36, part of the displacement member 33, and part of the vibrator member 34 overlap the center C1 of the region B as an example. FIG. 5 shows the case where the part of the bracket 36 and the part of the displacement member 33 overlap the center C1 of the region B. FIG. 6 shows the case where the part of the bracket 36 overlaps the center C1 of the region B.

In other words, the vibration exciter 30 is configured so that a distance between the center of the contact region A, in contact with the vibrator member 34, of the backboard 15 (the soundboard) and the center C1 of the region B extending in the width direction, that is, the left-right direction (the X-axis direction) from the contact region A is equal to or less than half of a length of a width of the bracket 36 of the support member 32 in the left-right direction (the X-axis direction). For example, the distance between the center of the contact region A and the center C1 of the region B may be half of a length of the width of the displacement member 33 in the left-right direction (the X-axis direction) or half of a length of the width of the vibrator member 34 in the left-right direction (the X-axis direction).

Similar to the position of the vibration exciter 30 shown in FIG. 5, FIG. 7 shows the vicinity of the vibration exciter 30 in the case where part of the displacement member 33 and part of the bracket 36 of the vibration exciter 30 overlap the center C1 of the region B. In other words, in FIG. 7, a distance d1 between a center C2 of the contact region A of the backboard 15 and the center C1 of the region B extending in the width direction, that is, in the left-right direction (the X-axis direction) from the contact region A is equal to or less than half of a length of the width of the displacement member 33 in the left-right direction (the X-axis direction).

As described above, arranging the vibration exciter 30 so that at least part of the vibration exciter 30 overlaps the center C1 of the region B extending in the width direction, that is, the left-right direction (the X-axis direction) from the contact region A, in contact with the vibrator member 34, of the backboard 15 makes it possible to suppress fluctuation in the vibration characteristics of the backboard 15 due to the weight of the vibration exciter 30 when the guitar 1 in which the vibration exciter 30 is attached to the backboard 15 is played. In particular, it is possible to suppress fluctuations in the vibration characteristics of the guitar 1 in the low-frequency range, and to improve the sound characteristics of the guitar 1.

Further, in order to suppress the fluctuation in the vibration characteristics of the guitar 1 in the low-frequency range, it is preferable that at least part of the vibrator member 34, specifically, part of the vibrator member 34 that contacts the backboard 15 is positioned closer to the bridge 18 than the sound hole 17 (sound hole) arranged on the top board 14 when viewed from a direction perpendicular to the surface of the backboard 15 (the soundboard).

### Second Embodiment

It has been described in the first embodiment described above with reference to FIG. 4 to FIG. 6 that the vibration exciter 30 is arranged so that at least part of the vibration exciter 30 overlaps the center C1 of the region B extending in the width direction, that is, the left-right direction (the X-axis direction) from the contact region A, in contact with the vibrator member 34, of the backboard 15 (the soundboard). However, the vibration exciter 30 may be arranged so that at least part of the vibration exciter 30 overlaps a symmetry axis of a predetermined vibration mode of the backboard 15 (the soundboard).

There is a vibration mode corresponding to a predetermined frequency (a predetermined frequency band) in the body 11 of the guitar body 10. The vibration mode means a resonance point corresponding to a predetermined frequency (a predetermined frequency band) and a vibration pattern of the resonance point.

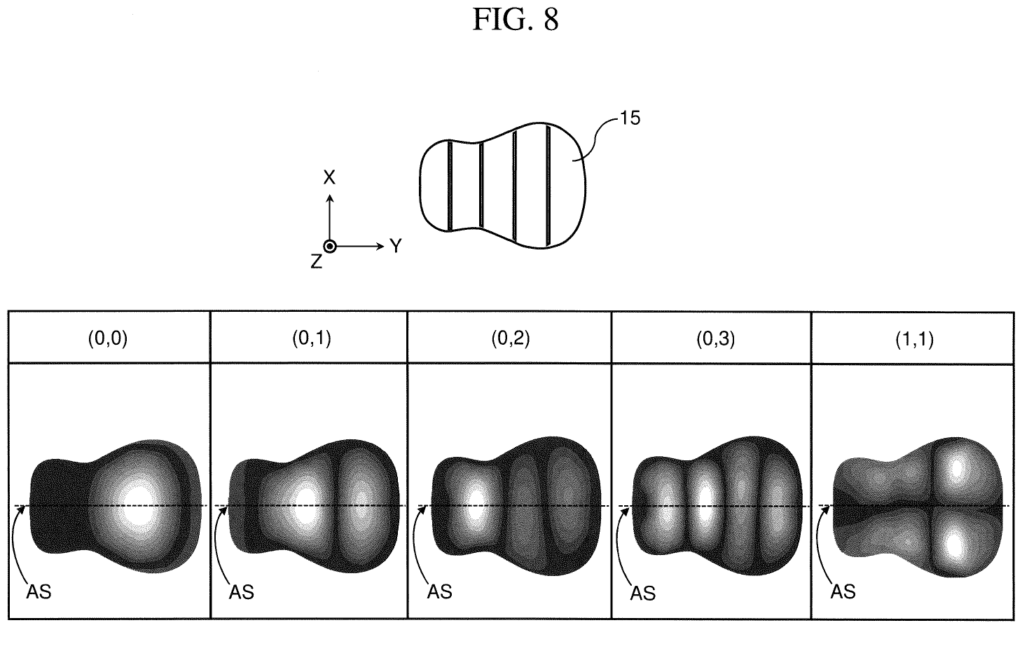

FIG. 8 is a diagram showing an example of a vibration mode of the backboard 15 of the guitar body 10 to which the vibration exciter 30 is not attached. FIG. 8 shows an example of five vibration patterns corresponding to (0,0) mode, (0,1) mode, (0,2) mode, (0,3) mode, and (1,1) mode. The displacement of parts shown in white is the largest, the displacement gradually decreases as the color becomes darker, and the displacement of parts shown in black is the smallest in the vibration patterns shown in FIG. 8.

As shown in FIG. 8, the vibration pattern corresponding to each vibration mode in the backboard 15 of the guitar body 10 is substantially line-symmetric about an axis AS. That is, the axis AS is a symmetry axis. The symmetry axis AS substantially aligns with a center line of the width of the backboard 15 in the left-right direction (the X-axis direction). In the case where the vibration exciter 30 is attached to the guitar body 10, at least part of the vibration exciter 30 is arranged so as to overlap the symmetry axis AS of the predetermined vibration mode, so that even if the vibration exciter 30 is attached to the backboard 15 (the soundboard), the fluctuation in the vibration characteristics of the backboard 15 can be suppressed.

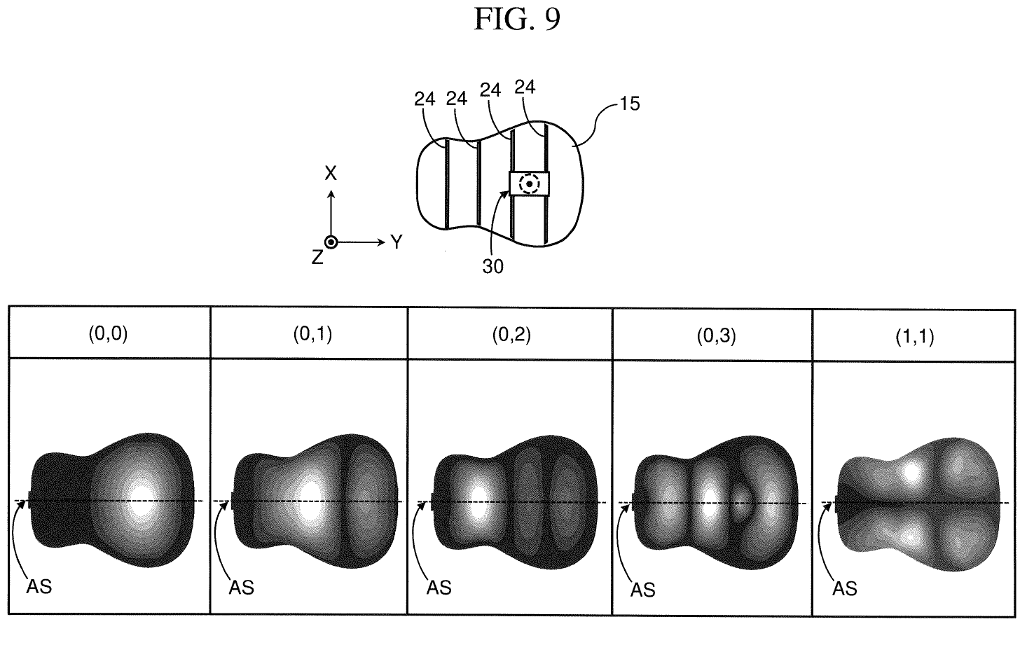

FIG. 9 is a diagram showing an example of the vibration mode of the backboard 15 in the case where at least part of the vibration exciter 30 is arranged so as to overlap the symmetrical axis AS of each vibration mode of the backboard 15. As shown in FIG. 9, the vibration exciter 30 is attached between the rib 24 on the right and the second rib 24 from the right in the figure among the four ribs 24 attached to the backboard 15. FIG. 9 shows vibration patterns corresponding to (0,0) mode, (0,1) mode, (0,2) mode, (0,3) mode, and (1,1) mode. The displacement of parts shown in white is the largest, the displacement gradually decreases as the color becomes darker, and the displacement of parts shown in black is the smallest in the vibration pattern shown in FIG. 9.

As shown in FIG. 9, in the case where at least part of the vibration exciter 30 is arranged so as to overlap the symmetry axis AS of each vibration mode of the backboard 15, the vibration pattern is substantially the same as the vibration pattern of the backboard 15 of the guitar body 10 to which the vibration exciter 30 is not attached shown in FIG. 8, and the symmetry of the vibration pattern is not disrupted. This indicates that the vibration characteristics of the backboard 15 (the soundboard) hardly fluctuate between the case where the vibration exciter 30 is not attached and the case where the vibration exciter 30 is attached, that is, the fluctuation of the vibration characteristics of the backboard 15 can be suppressed when the guitar in which the vibration exciter 30 is attached to the backboard 15 is played.

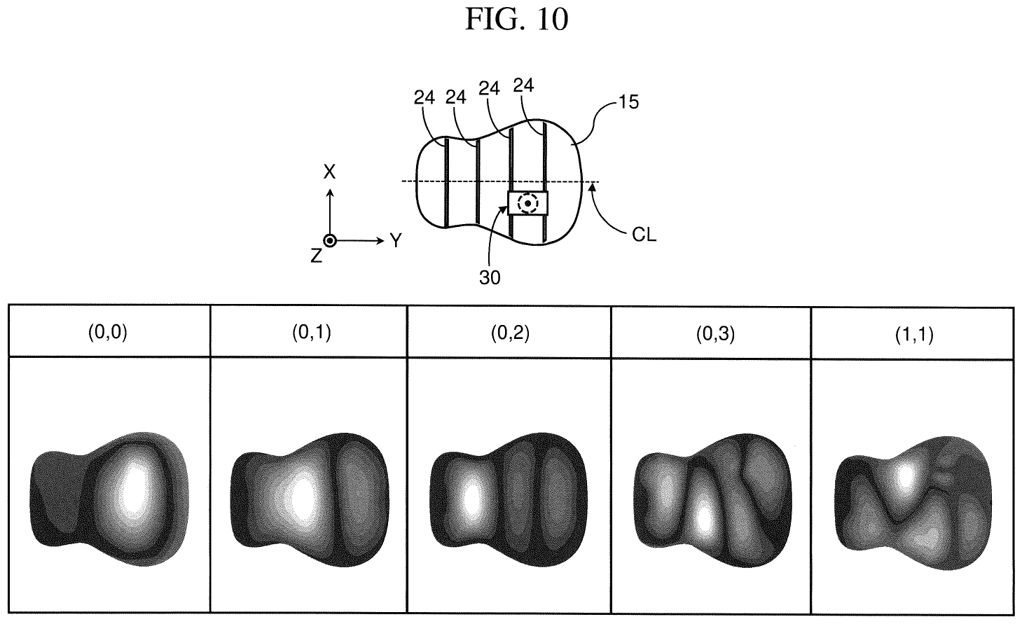

FIG. 10 is a diagram showing an example of the vibration mode of the backboard 15 in the case where the vibration exciter 30 is arranged so as not to overlap the symmetry axis AS of each vibration mode of the backboard 15. Specifically, FIG. 10 shows the vibration mode of the backboard 15 in the case where the vibration exciter 30 is attached to the backboard 15 so that the center of the vibration exciter 30 is positioned approximately 10 cm away from a center line CL of the width of the backboard 15 in the left-right direction (X-axis direction) and so that the vibration exciter 30 does not overlap the symmetry axis AS of each vibration mode of the backboard 15. FIG. 10 shows vibration patterns corresponding to (0,0) mode, (0,1) mode, (0,2) mode, (0,3) mode, and (1,1) mode. The displacement of parts shown in white is the largest, the displacement gradually decreases as the color becomes darker, and the displacement of parts shown in black is the smallest in the vibration patterns shown in FIG. 10.

As shown in FIG. 10, in the case where the vibration exciter 30 is arranged so as not to overlap the symmetry axis AS of each vibration mode of the backboard 15, the symmetry of the vibration pattern is disrupted in any of the vibration modes, and in particular, in the (0, 3) mode and the (1, 1) mode, the symmetry of the vibration pattern is largely disrupted. That is, in the case where the vibration exciter 30 is arranged so as not to overlap the symmetry axis AS of each vibration mode of the backboard 15, the vibration characteristics of the backboard 15 (the soundboard) fluctuate depending on the weight of the vibration exciter 30 between the case where the vibration exciter 30 is not attached and the case where the vibration exciter 30 is attached.

As described above, in the case where the vibration exciter 30 is attached to the backboard 15 (the soundboard) of the guitar body 10, at least part of the vibration exciter 30 is arranged so as to overlap the symmetry axis AS of the predetermined vibration mode of the backboard 15, so that it is possible to suppress fluctuations in the vibration characteristics of the backboard 15 due to the weight of the vibration exciter 30 when the guitar 1 in which the vibration exciter 30 is attached to the backboard 15 is played.

### Modification

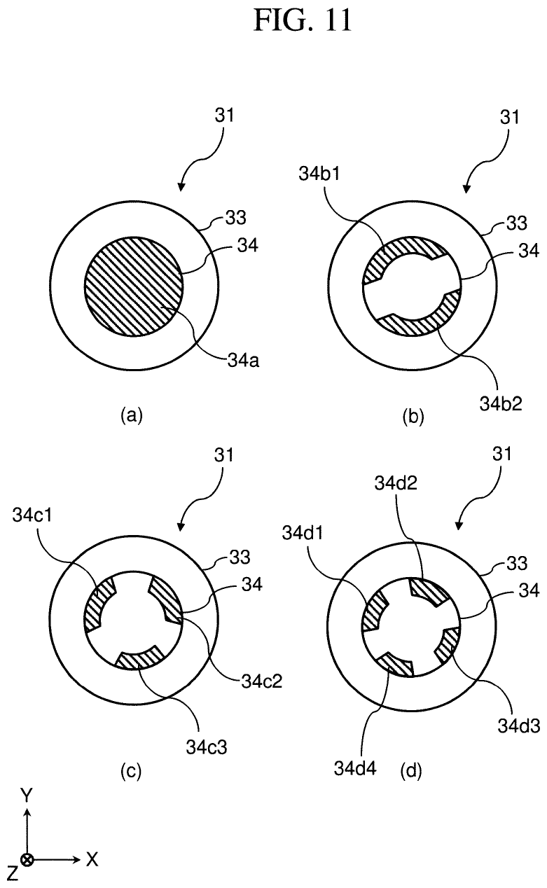

The present disclosure is not limited to the above-described embodiments, and includes various other modifications. For example, the above-described embodiments have been described in detail for the purpose of illustrating the present disclosure in an easy-to-understand manner, and are not necessarily limited to those having all the described configurations. Part of the configuration of an embodiment may be replaced with the configuration of another embodiment, and the configuration of another embodiment may be added to the configuration of an embodiment. Other configurations may be added or deleted for part of the configurations of each embodiment, or some of the configurations may be replaced with other configurations. Some modifications will be described below.
(1) The aspect in which the vibration exciter 30 is attached to the backboard 15 of the guitar body 10 has been described in the above embodiments. However, the acoustic member to which the vibration exciter 30 is attached is not limited to the backboard 15. For example, the vibration exciter 30 maybe attached to the top board 14 or the sides 16 of the guitar body 10. In the case where the vibration exciter 30 is attached to the top board 14, the vibration exciter 30 is arranged so as not to overlap the sound hole 17.
(2) The guitar is exemplified as a body of the instrument to which the vibration exciter 30 is attached in the above embodiments. However, the instrument of the present disclosure is not limited to a guitar, and may be another stringed instrument, a piano, a percussion instrument, or the like. For example, the acoustic member to which the vibration exciter 30 is attached may be a soundboard of a piano that emits sound in response to vibrations. In the case where the acoustic member is a soundboard of an upright piano, a width direction of the soundboard is a direction parallel to the short side of the soundboard. In addition, in the case where the acoustic member is a soundboard of a ground piano, a width direction of the soundboard is a direction parallel to a direction in which keys are arranged (a scale direction).
(3) The vibrator member 34 in the body 31 of the vibration exciter 30 is fixed to the inside surface 15a of the backboard 15 of the guitar body 10 and is in contact with the inside surface 15a in the above embodiments. The vibrator member 34 maybe configured so that the entire surface facing the inside surface 15a contacts the inside surface 15a, and part of the surface facing the inside surface 15a contacts the inside surface 15a. FIG. 11 is a view of the surface of the vibrator member 34 facing the inside surface 15a of the backboard 15 from the inside surface 15a side toward the Z-axis direction.

(a) to (d) in FIG. 11 show variations of the part (contact surface) of the vibrator member 34 that is in contact with the inside surface 15a. For example, as shown in (a), the entire surface of the vibrator member 34 that faces the inside surface 15a may contact a contact region of the inside surface 15a as a contact surface 34a. In addition, as shown in (b) to (d), part of the surface of the vibrator member 34 that faces the inside surface 15a may contact the contact region of the inside surface 15a as the contact surface 34a. In (b), the vibrator member 34 has two contact surfaces 34b1 and 34b2 as surfaces that face and contact the inside surface 15a. In (c), the vibrator member 34 has three contact surfaces 34c1, 34c2, and 34c3 as surfaces that face and contact the inside surface 15a. In (d), the vibrator member 34 has four contact surfaces 34d1, 34d2, 34d3, and 34d4 as surfaces that face and contact the inside surface 15a. As shown in FIG. 11, at least one part (contact surface) of the vibrator member 34 may contact the inside surface 15a. In this case, the contact region A of the backboard 15 in contact with the vibrator member 34 is a region surrounded by the contact surface/surfaces including each contact surface. The center of the contact region A may be the center of the smallest circle among virtual circles inscribed by each contact surface and may be the center of gravity of the entire contact surface. In addition, although the surface of the vibrator member 34 facing the inside surface 15a is circular and each contact surface is arranged along the circumference of the circle in FIG. 11, the contact surface may not be arranged along the circumference. In addition, the shapes of the vibrator member 34 and the displacement member 33 in a plan view are not limited to the circular shape. For example, the shapes of the vibrator member 34 and the displacement member 33 in a plan view may be polygons such as triangles and squares. In this case, the surface of the vibrator member 34 facing the inside surface 15a may also have a polygonal shape. In this case, the center of the contact region A may be a point equidistant from each side or vertex, the center of the smallest circle of the virtual circles inscribed by each contact surface, or the center of gravity of the entire contact surface.

What is claimed is:

1. An instrument comprising:
a body including a soundboard that transmits a vibration of a sound source, and
a vibration exciter configured to vibrate the soundboard in response to an input signal, the vibration exciter comprising:
a vibrator member attached to the soundboard and configured to vibrate the soundboard in response to the input signal;
a displacement member configured to displace relative to the vibrator member in response to the input signal; and
a support member including an elastic member and supporting the displacement member via the elastic member with respect to the body,
wherein at least part of the vibration exciter overlaps a center of a region of the soundboard that extends in a width direction from a contact region of the soundboard where the soundboard contacts with the vibrator member.

2. The instrument according to claim 1, wherein the input signal is generated based on a signal indicating the vibration of the sound source.

3. The instrument according to claim 1, wherein a weight of the displacement member is heavier than a weight of the vibrator member.

4. The instrument according to claim 1, wherein at least part of the displacement member overlaps the center of the region of the soundboard.

5. The instrument according to claim 1, wherein at least part of the vibrator member overlaps the center of the region of the soundboard.

6. The instrument according to claim 1, wherein:
the body is a guitar body and includes a sound hole and a bridge,
the soundboard includes a top board disposed adjacent guitar strings, and
at least part of the vibrator member is positioned closer to the bridge than the sound hole in direction along where the guitar strings extend.

7. The instrument according to claim 1, wherein the support member further includes:
a bracket attached to the elastic member, which is attached to the displacement member; and
at least one leg extending from the bracket and contacting the soundboard.

8. An instrument comprising:
a body including a soundboard that transmits a vibration of a sound source; and
a vibration exciter configured to vibrate the soundboard in response to an input signal, the vibration exciter comprising:
a vibrator member attached to the soundboard and configured to vibrate the soundboard in response to the input signal;
a displacement member configured to displace relative to the vibrator member in response to the input signal; and
a support member including an elastic member and supporting the displacement member via the elastic member with respect to the body,
wherein a distance between a center of a contact region of the soundboard in contact with the vibrator member and a center of a region extending in a width direction from the contact region is equal to or less than half of a length of the support member in the width direction.

9. The instrument according to claim 8, wherein the input signal is generated based on a signal indicating the vibration of the sound source.

10. The instrument according to claim 8, wherein a weight of the displacement member is heavier than a weight of the vibrator member.

11. The instrument according to claim 8, wherein the support member further includes:
a bracket attached to the elastic member, which is attached to the displacement member; and
at least one leg extending from the bracket and contacting the soundboard.

12. The instrument according to claim 11, wherein the at least one leg comprises a pair of legs extending from the bracket and contacting an underside of the soundboard.

13. The instrument according to claim 8, wherein
the body is a guitar body and includes a sound hole and a bridge,
the soundboard includes a top board disposed adjacent guitar strings, and
at least part of the vibrator member is positioned closer to the bridge than the sound hole in a direction along where the guitar strings extend.

14. An instrument comprising:
a body including a soundboard that transmits a vibration of a sound source; and
a vibration exciter configured to vibrate the soundboard in response to an input signal, the vibration exciter comprising:
a vibrator member fixed to the soundboard and configured to vibrate the soundboard in response to the input signal;
a displacement member configured to displace relative to the vibrator member in response to the input signal; and
a support member including an elastic member and supporting the displacement member via the elastic member with respect to the body,
wherein at least part of the vibration exciter overlaps a symmetry axis of a predetermined vibration mode in the soundboard.

15. The instrument according to claim 14, wherein the input signal is generated based on a signal indicating the vibration of the sound source.

16. The instrument according to claim 14, wherein a weight of the displacement member is heavier than a weight of the vibrator member.

17. The instrument according to claim 14, wherein at least part of the displacement member overlaps the symmetry axis.

18. The instrument according to claim 14, wherein at least part of the vibrator member overlaps a symmetry axis.

19. The instrument according to claim 14, wherein:
the body is a guitar body and includes a sound hole and a bridge,
the soundboard includes a top board disposed adjacent guitar strings, and
at least part of the vibrator member is positioned closer to the bridge than the sound hole in a direction along where the guitar strings extend.
